(19) United States
(12) Patent Application Publication
(10) Pub. No.: US 2019/0275559 A1
(43) Pub. Date: Sep. 12, 2019

(54) FORMATION OF THIN FILM LIKE ASSEMBLY BY SOLVENT NON-EVAPORATIVE METHOD USING CENTRIFUGE

(71) Applicant: INDIAN INSTITUTE OF TECHNOLOGY DELHI, New Delhi (IN)

(72) Inventors: Suddhasatwa Basu, New Delhi (IN); Ravi Tejasvi, New Delhi (IN)

(21) Appl. No.: 16/118,949

(22) Filed: Aug. 31, 2018

(30) Foreign Application Priority Data
Mar. 6, 2018 (IN) 201811008269

(51) Int. Cl. B05D 1/00; C03C 17/22

(52) U.S. Cl. CPC B05D 1/005; C03C 2218/116; C03C 2217/281; C03C 17/225

(57) ABSTRACT

The present invention relates to a method for manufacturing a thin film of nanomaterial, the method comprising forming a non-precipitating dispersion solution of nano-particles in a solvent, centrifuging the dispersion solution at a controlled temperature, pressure, and centrifugation velocity and using a combination of centrifugal/centripetal force, hydrodynamic friction force, and weak interactive forces (Van der Waals and similar) in centrifuging manner to form a thin film over the substrate.

### FIELD OF INVENTION

The present invention focuses on deposition of thin films of material which are morphologically 2-dimensional, do not respond to electrochemical deposition methods, and are insoluble in common solvents (exfoliated carbon nitride and reduced graphene oxide are typical representatives of the material class).

### BACKGROUND OF THE INVENTION

Spin coating is one of the most favored techniques of depositing the nanomaterial thin film on various substrates for electro-catalytic applications. In there, catalyst nanoparticles are dispersed in a volatile solvent and the dispersion is poured dropwise on a substrate, rotating under atmospheric conditions or under vacuum. The drop acquires the shape of a thin film due to centrifugal drainage and the solvent evaporation. The salient benefits of the technique are simplicity, inexpensiveness and facile nature. However, spin coating technique faces special challenges for thin film deposition on rough substrates. There, the technique renders uneven distribution of catalyst and local piling of the nanomaterial. Apart from these, the evaporation of the solvent into the atmosphere is a problem should be mitigated owing to the toxicities of the commonly used media like toluene, acetone, methyl ethyl ketone, di methyl ether, iso-propanol (IPA), acetonitrile, and others. Since the technique of spin coating fundamentally relies on centrifugal drainage, i.e. the escape of solvent from the dispersed droplet, the release of the toxic media in the atmosphere is inevitable.

Hence, there is a need to develop a method which enables deposition of nanomaterial thin film on various substrates for electro-catalytic applications.

### SUMMARY OF THE INVENTION

In one aspect of the present invention a method for manufacturing a thin film of nanomaterial is provided. The method comprises forming a non-precipitating dispersion solution of nano-particles in a solvent, centrifuging the dispersion solution at a controlled temperature, pressure, and centrifugation velocity and using a combination of centrifugal/centripetal force, hydrodynamic friction force, and weak interactive forces (Van der Waals and similar) in centrifuging manner to form a thin film over the substrate.

In one embodiment of the present invention, the method of the present invention where the step of forming includes exfoliating a nano-material in a suitable solvent to form a non-precipitating dispersion which does not chemically react with the substrate or the other constituents of the assembly. Further, the method comprises varying a speed of the centrifuge to vary a thickness of the thin-film. The speed of the centrifuge can be in the range of 8 k-32 k.

In another embodiment of the present invention, the solvent can be selected from toluene, acetone, methyl ethyl ketone, dimethyl ether, iso-propanol, or acetonitrile. The controlled temperature at 1-atmosphere pressure is below a vaporization temperature of the solvent. The temperature is below a vaporization temperature of the solvent at 1-atmosphere pressure or preferably below 25° C. (whichever is lower).

In a further embodiment of the present invention, the nano-material includes graphitic carbon nitride. The substrate includes glass, titanium dioxide, silica, or metal.

In one aspect of the present invention, the method of the present invention provides a substrate having a thin-film of nano-material deposited on it. The substrate having a thin-film where the substrate includes glass, titanium dioxide, silica, or metal. The substrate having a thin-film, where the thin film is of a nanomaterial. The substrate having a thin-film where the nano-material includes graphitic carbon nitride. The use of the substrate having a thin-film for electrocatalytic applications

### DESCRIPTION OF THE FIGURES

FIGS. 1(a), 1(c), 1(e), 1(g) and 1(i) shows the Field Emission Scanning Electron Microscope (FESEM) images of eC₃N₄ thin film samples obtained at centrifugation speeds of 8 k, 16 k, 24 k, 32 k rpm, and by spin coating.

FIGS. 1(b), 1(d), 1(f), 1(h), and 1(j) shows the Atomic Force Microscope (AFM) images of eC₃N₄ thin film samples obtained at centrifugation speeds of 8 k, 16 k, 24 k, 32 k rpm, and by spin coating.

FIG. 2 shows the OSP profiles of samples and describe the linear variation in the height of the deposited thin films.

FIG. 3 showcases a comparison of PEC activities of the TiO₂/eC₃N₄ heterojunctions formed at different centrifugation speeds and by spin coating technique.

### DETAILED DESCRIPTION OF INVENTION

The present invention relates to a formation of thin film of nanomaterial. The thin film is morphologically 2-dimensional, do not respond to electrochemical deposition methods, and are insoluble in common solvents (exfoliated carbon nitride and reduced graphene oxide are typical representatives of the material class).

In one aspect of the present invention a method for manufacturing a thin film of nanomaterial is provided. The method comprises forming a non-precipitating dispersion solution of nano-particles in a solvent. The dispersion solution is centrifuged at a controlled temperature, pressure, and centrifugation velocity and using a combination of centrifugal/centripetal force, hydrodynamic friction force, and weak interactive forces (Van der Waals and similar) in centrifuging manner to form a thin film over the substrate. The centrifugal force has been used to segregate particles, whereby, the gyration of the holder containing the dispersion at a fixed angular velocity imparts the centrifugal force on dispersed particles. When centrifugal force overcomes the drag experienced by the particles in the solvent, it starts depositing to the wall of the holder containing a substrate placed perpendicular to the direction of particle movement. Here, increasing the gyration velocity can make even smaller particles to deposit on to the substrate. Also, as particles in the dispersion originally behave as individual entities, which are differentiable only by their masses, they are susceptible to lateral as much as axial movement leading to aggregation and stacking.

During centrifugation, the heavier particles experiences a larger centrifugal force, which easily overcomes the drag offered by solvent and therefore heavier particles deposit first on to the glass substrate. It causes the formation of rough thin films with heavier particles placed at significant distances. As the centrifugation speed increases, the amount of centrifugal force experienced by moderate sized particles increases to overcome drag and they deposit on heavier particles as well as in vacant spots. However, due to increase in centrifugal force and non-additive interactions of incoming particles to the neighboring particles, the deposited layer of heavier particles experience compression leading to a generation of a uniform thin layer of coating. Thus, the increment in the centrifugation speed causes improvement in the uniformity of the deposited thin film.

In one embodiment of the present invention, the step of forming includes exfoliating a nano-material in a suitable solvent to form a non-precipitating dispersion which does not chemically react with the substrate or the other constituents of the assembly.

In another embodiment of the present invention, the method comprises varying a speed of the centrifuge to vary a thickness of the thin-film. The speed of the centrifuge can be in the range of 8 k-32 k.

In another embodiment of the present invention, the solvent can be selected from toluene, acetone, methyl ethyl ketone, dimethyl ether, iso-propanol, or acetonitrile.

In yet another embodiment of the present invention, the controlled temperature at 1-atmosphere pressure can be below a vaporization temperature of the solvent. The temperature can be below a vaporization temperature of the solvent at 1-atmosphere pressure or preferably below 25° C. (whichever is lower).

In a further embodiment of the present invention, the nano-material can include graphitic carbon nitride. The substrate can include glass, titanium dioxide, silica, or metal.

In one aspect of the present invention, the method of the present invention provides a substrate having a thin-film of nano-material deposited on it. The substrate having a thin-film where the substrate can include glass, titanium dioxide, silica, or metal. The thin film can be a nanomaterial. The nano-material can include graphitic carbon nitride.

In one aspect of the present invention, the substrate having a thin-film can be used for electrocatalytic applications.

The method of the present invention not only results in depositing a uniform thin layer of exfoliated carbon nitride (eC₃N₄) nanoflakes on glass substrate but also stops the solvent, IPA, from atmospheric release. Furthermore, to demonstrate the catalytic activity of the deposited film, anatase TiO₂ substrates with eC₃N₄ nanoflakes using the same technique was decorated. The photo-electrocatalytic (PEC) activity of thus formed heterojunction using centrifuge technique is compared with the PEC performance of the heterojunction formed using spin coating technique.

### EXAMPLES

The following example further illustrate the present invention and is not to be construed as limiting the scope thereof.

### Example 1

The prepared graphitic carbon nitride (g-C₃N₄) was exfoliated in IPA to produce a homogeneous milky white dispersion of eC₃N₄ in IPA. The 2 ml capacity screw cap polypropylene vials (inner diameter 10 mm) were filled with 1 ml dispersion and a cleaned borosilicate glass substrates (5×5 mm²) were carefully placed at the bottom of the vials in the perpendicular direction of centrifugal force. The capped vials were then placed in the rotor and the centrifugation was done for constant time (10 minutes) at a controlled temperature of 25° C. and at various speeds using a Hitachi Himac CS120GXII ultra-micro centrifuge. Samples prepared at centrifugation speeds of 8 k rpm, 24 k rpm, and 32 k rpm are hereafter named as 8 k, 16 k, 24 k, and 32 k respectively, while samples were named as SpinC when prepared using spin coating method at 10 k rpm using same dispersion. The glass substrates were dried and weighed, before and after thin film deposition, to calculate the loading of catalyst on the substrate for any given centrifugation speed. To form the heterojunction, glass substrates were replaced by anatase TiO₂ substrates. These TiO₂ substrates were prepared by digesting clean Ti metal foils (5×5×0.25 mm³) in a 100 mM solution of hydrofluoric acid in 30% hydrogen peroxide, at 80° C. for 60 hrs. The heterojunctions were designated as 8 kH, 24 kH, 32 kH, and SCH respectively based on their formations at centrifugation speeds of 8 k, 24 k, 32 k, and by spin coating.

The field emission scanning electron microscope (FESEM) images were taken by FEI Quanta 200 FESEM instrument. Atomic force microscope (AFM) analysis of prepared films was done using Bruker Innova A2. Optical surface profiling (OSP) was done using MicroXAM 100 optical profiler. All PEC activity measurements were carried out in 1 M NaOH solution with Ag/AgCl in saturated KCl (0.1976 V vs. RHE at room temperature) as the reference electrode, under dark and illuminated (800 W/m2, λ≥420 nm) conditions using Zahner CIMPS-2 photo electrochemical workstation. Electrochemical impedance spectroscopy (EIS) studies were done at onset potential (0.91 V vs. reference electrode) in the frequency range of 0.1 Hz to 100 kHz with the perturbation amplitude of 10 mV.

### Example 2

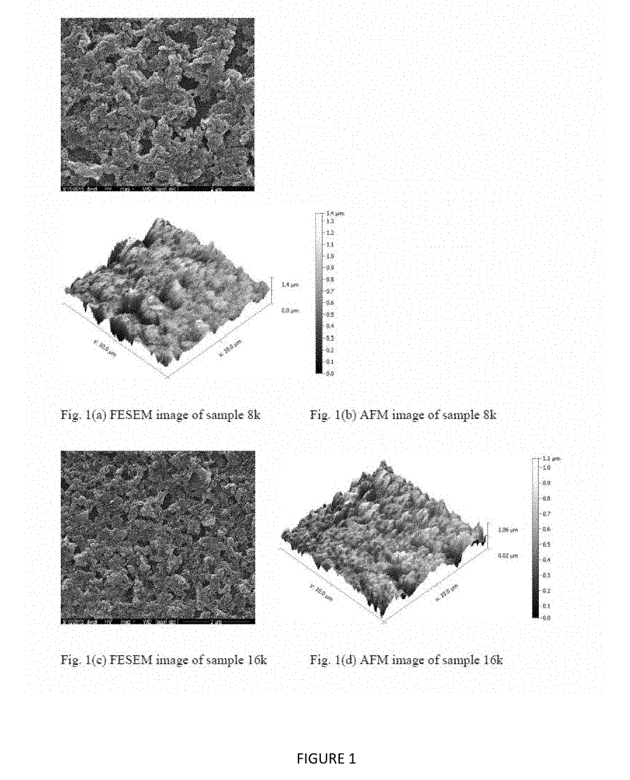

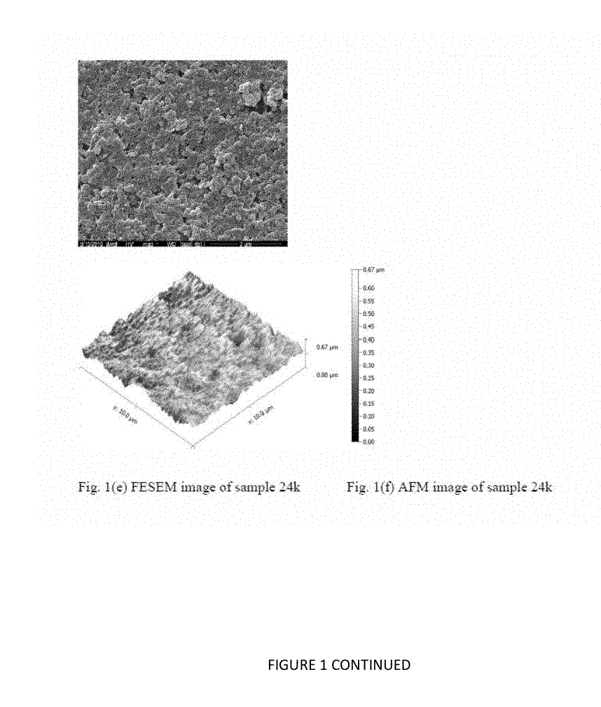

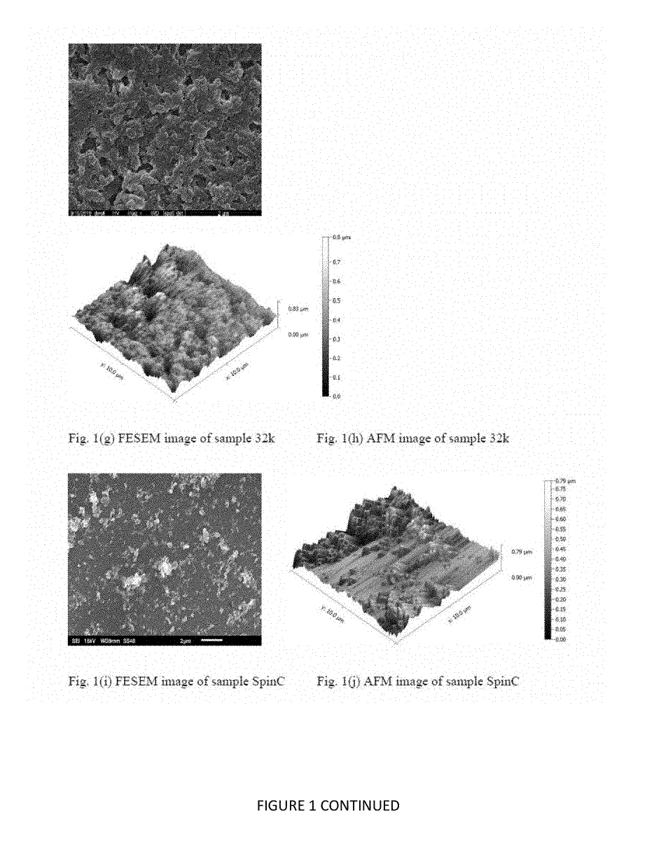

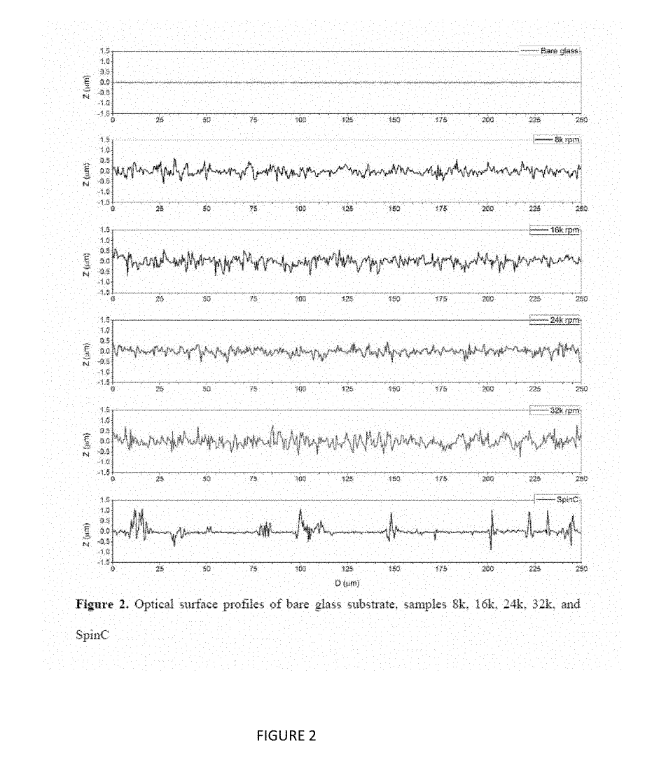

The FESEM images of eC₃N₄ thin film samples obtained at centrifugation speeds of 8 k, 16 k, 24 k, 32 k rpm, and by spin coating, are shown in FIGS. 1(a), 1(c), 1(e), 1(g) and 1(i) while respective AFM images are shown in FIGS. 1(b), 1(d), 1(f), 1(h), and 1(j). FIG. 2 shows the OSP profiles of samples and describe the linear variation in the height of the deposited thin films. It is observed through FESEM images that the increment in centrifugation speed produces compactness in the deposited nanoflakes of eC₃N₄. In the sample 8 k (FIG. 1(a)) the deposited nanoflakes have a large number of peaks which are significantly reduced with the increase in centrifuge rotation speed as seen in samples 16 k (FIGS. 1(c)) and 24 k (FIG. 1(e)). AFM images of FIGS. 1(b), 1(d), and 1(f) reveals the same nature of observation. The OSP profiles of pristine substrate (bare glass), samples 8 k, 16 k, 24 k, 32 k, and Spin C are shown in FIG. 2. It suggests that compared to other samples, the optically assessable linear surface topography is smoother for sample 24 k. It further corroborates the observations of FESEM and AFM analysis.

For same volume of dispersion and same centrifugation time, the amount of the catalyst deposited on the substrate, known as loading, varied for varying centrifugation speeds. While the catalyst mass dispersed in the original dispersion was 0.96 mg/mL, the deposited catalyst loading weighed 0.15 mg, 0.20 mg, 0.26 mg, and 0.36 mg for 8 k, 16 k, 24 k, and 32 k samples, respectively. The catalyst deposited on the spin-coated sample weighed 0.16 mg. The samples also varied in deposited film thickness with average film thickness being 762.4 nm, 654.9 nm, 372.6 nm, 397.2 nm, and 790.7 nm for 8 k, 16 k, 24 k, 32 k, and spin-coated samples, respectively.

During centrifugation, the heavier particles experiences a larger centrifugal force (˜10⁻⁷ N), which easily overcomes the drag (˜10⁻⁹ N) offered by solvent and therefore heavier particles deposit first on to the glass substrate. It causes the formation of rough thin films with heavier particles placed at significant distances. As the centrifugation speed increases, the amount of centrifugal force experienced by moderate sized particles increases (˜10⁻⁸ N) to overcome drag and they deposit on heavier particles as well as in vacant spots (valleys). However, due to increase in centrifugal force and non-additive interactions of incoming particles to the neighboring particles, the deposited layer of heavier particles experience compression leading to a generation of a uniform thin layer of coating. Thus, the increment in the centrifugation speed causes improvement in the uniformity of the deposited thin film.

The surface roughness factors (SRF), defined as ratio of measured surface area and geometric surface area, as calculated on the basis of AFM analysis, are 1.6507, 1.4341, and 1.1503 for samples 8 k, 16 k, and 24 k, respectively, whereas the pristine substrate has the SRF of 1.0003. The feature heights variation decreased from sample 8 k towards sample 24 k. The respective ranges of height variation were ˜1.41, ˜1.14, and ˜0.67 μm for samples 8 k, 16 k, and 24 k, respectively. However, for sample 32 k, the variation increased to be in the range of ˜0.83 μm, which indicates that increasing the centrifugation speed beyond a certain point increases surface roughness. At higher centrifugation speeds, much smaller size particles experiences centrifugal force (˜10⁻⁹N) which is just enough to overcome the drag (˜10⁻⁹ N). The net resultant force acting on the particle is now comparable to van der Waals force (˜10⁻²⁰ N), when the particles are very close to the deposited particles leading to deviation of traversing path towards peaks of the deposited particles. It is perhaps the reason for the slight increase in surface roughness from 1.1503 (sample 24 k) to 1.1820 (sample 32 k). On the other hand, SEM, AFM, and OSP analysis of the spin-coated sample suggest that spin coating does not produce uniform compact thin film under the same conditions. The SRF for spin coated sample is 1.5903 which is comparatively high, while the range of height variation is ˜0.79 μm.

### Example 3

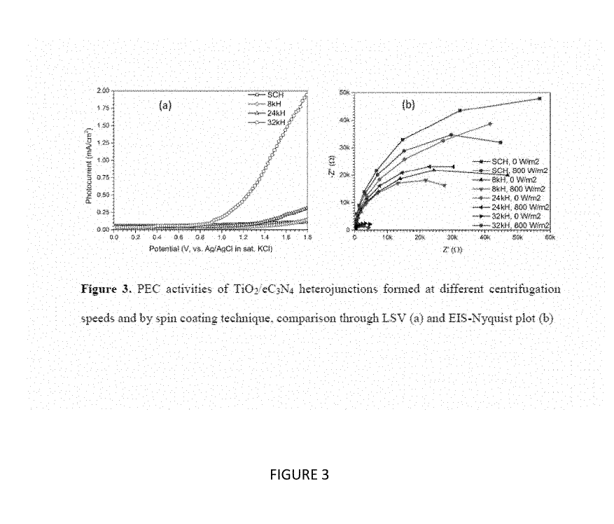

FIG. 3 showcases a comparison of PEC activities of the TiO₂/eC₃N₄ heterojunctions formed at different centrifugation speeds and by spin coating technique. The heterojunctions are studied for their PEC activity as photoanode in a photo-electrochemical cell for simulated solar water splitting at room temperature. The linear sweep voltammetry study (FIG. 3(a)) shows that the photocurrent improved for sample 32 kH by about 20 times vis-à-vis that for sample SCH. The photocurrents (at 1.8 V vs. reference electrode) are 0.115, 0.153, 0.313, and 1.986 mA/cm² for samples SCH, 8 kH, 24 kH, and 32 kH respectively. The EIS-Nyquist plot reveals that the impedance has also reduced significantly for sample 32 kH as compared to sample SCH. It is seen that in the high frequency region, heterojunction 32 kH has lower impedance than that in dark. Thus, LSV and EIS studies, collectively show that a more efficient heterojunction is formed using our centrifuge based technique rather than by spin coating.

The most striking benefit of the centrifuge technique of deposition is the possibility of reuse of the solvent. During, centrifugation, the vials containing the dispersion and the substrate are capped which prevented solvent evaporation which is aided by controlling the temperature to maintain 25° C. After deposition, the remaining dispersion from the vials can be collected in order to recover the solvent. Another benefit of the technique is that, unlike spin coating, it does not depend on the substrate surface texture for smooth drop spreading. Irrespective of surface texture, centrifugal deposition method gives rise to a thoroughly uniform film allowing better intimate contact of the heterojunction formation, sensitizer coating, etc. Further, the technique is easy to scale-up as the large size centrifugation systems are available, contrary to the spin coating unit.

### CONCLUSION

Spin coating is conventionally preferred technique of thin film coating for nanomaterials which cannot be electrodeposited. The major drawback of the method is fugitive emissions of toxic solvent vapors. The present invention provides a method to assemble a thin film of nanomaterials without the risk of such emissions through centrifuge technique. A high speed centrifuge was used to deposit layers of exfoliated carbon nitride (eC₃N₄) nanoflakes on glass substrates at various speeds of rotation. The deposited films were analyzed through field emission scanning electron microscope, atomic force microscope, and optical surface profilometer. The films varied in terms of surface roughness distribution depending on centrifugal force i.e., rotational speed. The uniform and the smooth film (SRF of 1.15) is obtained at an optimum speed of 24,000 rpm. It is found that rpm higher than the optimum value usher secondary layer formation leading to slightly higher surface roughness at 32 k rpm. The phenomenon is explained based on the interplay of different forces acting on the particles, namely, centrifugal force, drag and van der Waals force. To demonstrate the utility of the technique for thin film deposition in catalytic applications, TiO₂/eC₃N₄ heterojunctions by depositing films of eC₃N₄ on anatase TiO₂ substrates using centrifuge and spin coating techniques was created. The photo-electrocatalytic activities, of the heterojunctions in 1 M NaOH solution, were measured by linear sweep voltammetry and electrochemical impedance spectroscopy. The heterojunction formed by the centrifuge based technique showed higher photocurrent (˜2.0 mA/cm² at 1.8 V potential vs. Ag/AgCl in sat. KCl) and reduced impedance compared to that for heterojunction formed by spin-coating method.

Therefore, the present invention provides a method which enables deposition of thin films of material which are morphologically 2-dimensional, do not respond to electrochemical deposition methods, and are insoluble in common solvents. The present invention also provides a method to deposit the thin films of aforesaid materials on substrates of any surface texture. Also, the present invention results in the preservation the solvent/dispersion media.

The foregoing description of the invention has been set merely to illustrate the invention and is not intended to be limiting. Since modifications of the disclosed embodiments incorporating the spirit and substance of the invention may occur to person skilled in the art, the invention should be construed to include everything within the scope of the disclosure.

1. A method for manufacturing a thin film of nanomaterial, the method comprising:
a. forming a non-precipitating dispersion solution of nano-particles in a solvent;
b. centrifuging the dispersion solution at a controlled temperature, pressure, and centrifugation velocity and using a combination of centrifugal/centripetal force, hydrodynamic friction force, and weak interactive forces (Van der Waals and similar) in centrifuging manner and to form a thin film over the substrate.

2. The method as claimed in claim 1, wherein the step of forming of step (a) includes exfoliating a nano-material in a suitable solvent to form a non-precipitating dispersion of nanoparticle which does not chemically react with the substrate or the other constituents of the assembly.

3. The method as claimed in claim 1, further comprising varying a speed of the centrifuge to vary a thickness of the thin-film.

4. The method as claimed in claim 3, wherein the speed of the centrifuge is in the range of 8 k to 32 k rpm.

5. The method as claimed in claim 1, wherein the solvent comprises toluene, acetone, methyl ethyl ketone, dimethyl ether, iso-propanol, or acetonitrile.

6. The method as claimed in claim 1, wherein the controlled temperature at 1-atmosphere pressure is below a vaporization temperature of the solvent.

7. The method as claimed in claim 1, wherein the temperature is below 25° C.

8. The method as claimed in claim 1, wherein the nano-material includes graphitic carbon nitride.

9. The method as claimed in claim 1, wherein the substrate comprises glass, titanium dioxide, silica, or metal.

10. A substrate having a thin-film obtained by the method as claimed in claim 1.

11. The substrate having a thin-film as claimed in claim 10, wherein the substrate comprises glass, titanium dioxide, silica, or metal.

12. The substrate having a thin-film as claimed in claim 10, wherein the thin film is of a nanomaterial.

13. The substrate having a thin-film as claimed in claim 10, wherein the nano-material comprises graphitic carbon nitride.

14. Use of the substrate having a thin-film as claimed in claim 10 for electrocatalytic applications.
